(19) United States
(12) Patent Application Publication
(10) Pub. No.: US 2009/0199921 A1
(43) Pub. Date: Aug. 13, 2009

(54) COMPOSITE AIR TANK FOR VEHICLE AIR BRAKE AND METHOD FOR MANUFACTURING

(76) Inventors: Richard Pickering, Urbana, OH (US); Frederick Gochenouer, Mechanicsburg, OH (US); Eugene Brooks, Quincy, OH (US)

Correspondence Address: SCHIFF HARDIN, LLP;PATENT DEPARTMENT, 6600 SEARS TOWER, CHICAGO, IL, 60606-6473, US

(21) Appl. No.: 12/028,921

(22) Filed: Feb. 11, 2008

(51) Int. Cl. A01G 25/09

(52) U.S. Cl. 137/899.4; 29/592

(57) ABSTRACT

A composite air tank is provided comprising a cylindrical tube comprising two open ends; two endcaps, at least one of which comprises one or more ports, the two endcaps being affixed to respective end portions of the cylindrical tube, and a composite resin material that covers a portion of the endcap and a portion of the tube. An appertaining method for forming an air tank is also provided, comprising forming two endcaps, at least one having one or more ports, affixing the two endcaps to respective ends of an open tube, applying a composite resin material to cover a part of the endcaps and the tube, and curing the composite resin material.

### BACKGROUND

The present invention relates to a composite air tank that can be used for truck air brake applications.

Air tanks for brake applications are typically charged with 135 psi (pounds per square inch) (150 psi max rated) air pressure for the purpose of providing pressurized air to stop a vehicle. Traditionally, air tanks used in this application are made of steel and/or aluminum. However, these tanks tend to be heavy, which increases costs of operation, and may be susceptible to corrosion.

Composite filament winding is a process used to make many lightweight, high pressure vessels, such as self-contained breathing tanks for fire-fighters, and compressed natural gas tanks. Tanks of this nature have typically in the past been constructed of a liner (metal or plastic—blow molded or rotocast) with fiberglass such as Kevlar, E-Glass, or Carbon Fiber, impregnated with a thermosetting resin, such as Epoxy or Vinyl-Ester Epoxy. They are typically wound in such a fashion that the only openings available are center ports on either or both ends of the cylinder. If side ports or endcap ports are required, typically holes are drilled after the winding process and fittings are assembled in place. This machining operation after winding may weaken the fiberglass in a localized area, as well as provide the opportunity for a leak path to develop.

### SUMMARY

The present invention is directed to a lightweight and corrosion resistant air tank that makes use of composite materials. This results in a lighter and more durable tank that translates into higher payload capability and better fuel economy for commercial trucks. Such a tank may also be advantageously used in military vehicles with similar benefits.

Accordingly, a composite air tank is provided comprising: a cylindrical tube comprising two open ends; two endcaps, at least one of which comprises one or more ports, the two endcaps being affixed to respective end portions of the cylindrical tube; and a composite resin material that covers a portion of the endcap and a portion of the tube.

Similarly, a method for forming an air tank is provided, comprising: forming two endcaps, at least one having one or more ports; affixing the two endcaps to respective ends of an open tube; applying a composite resin material to cover a part of the endcaps and the tube; and curing the composite resin material.

### DESCRIPTION OF THE DRAWINGS

The present invention is described in terms of a preferred embodiment illustrated in the drawings and described in more detail below.

FIG. 1 is a pictorial isometric view of the air tank assembly;

FIG. 2 is a pictorial isometric view of the air tank endcap; and

FIG. 3 is a flowchart illustrating the method steps.

### DETAILED DESCRIPTION OF THE PREFERRED EMBODIMENTS

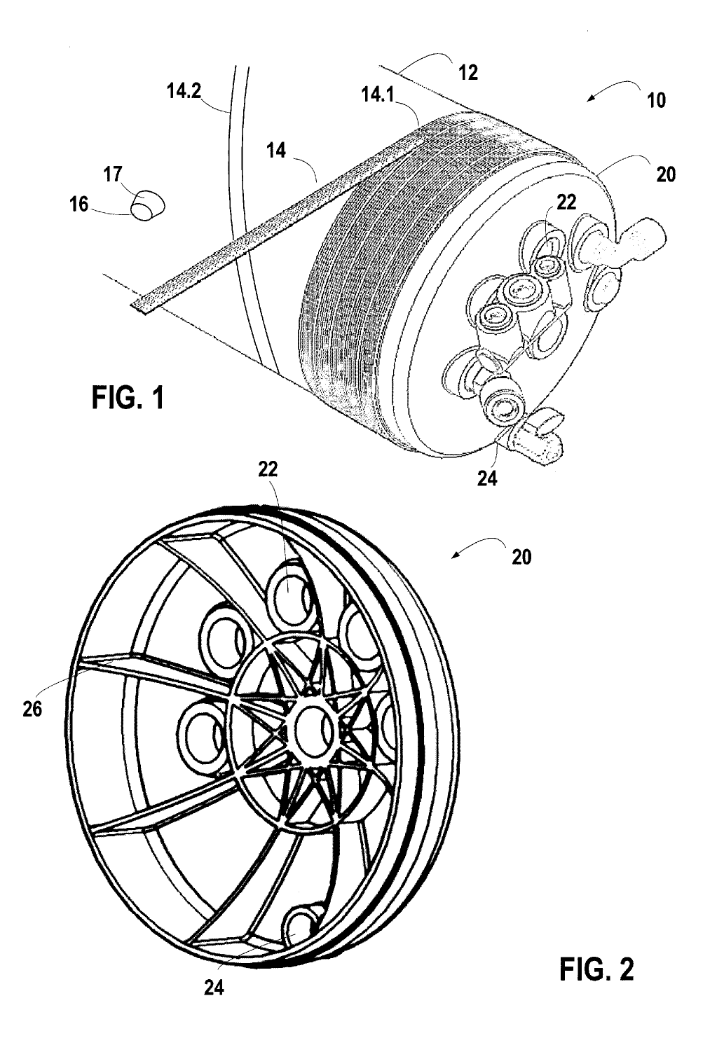

FIG. 1 illustrates the air tank assembly 10 that incorporates a low-domed endcap 20 design, which may be manufactured as, e.g., an injection-molded part, although other well-known manufacturing methods may be used to produce the endcap 20. This may be similar to the shape of a corresponding steel or aluminum endcap 20, and therefore is more likely to fit in the same envelope on a vehicle than a high-domed version, which has to be longer than its steel or aluminum counterpart in order to contain the same volume of air.

The present design incorporates a sheet, preferably made of plastic, which is rolled into a cylinder 12 and laser-welded or bonded with adhesive, then joined to each endcap 20 via either laser weld or adhesive. When plastic is used, in a preferred embodiment, a polyester film may be utilized having a thickness of approximately 0.01″ and a width of 40″. The sheet should be able to withstand temperatures of between −99° F. to +300° F. and have a high tensile strength. A material conforming to Underwriter's Laboratory spec. UL 94VTM2 is a preferred material.

Using a sheet is advantageous over using a blow-molded liner or a rotocast liner because there is no tooling cost associated with making different sizes, such as a mold. Different lengths are simply cut and bonded to the endcaps 20 to make different length configurations. The endcap-plastic sheet liner assembly 10, once complete, serves as a bladder, keeping the air from leaking out of the assembly 10.

In one embodiment, side ports 16 are attached to the plastic sheet tube 12 prior to winding via either laser welding or adhesive bonding.

Once the endcap-liner subassembly 10 is made, a composite material, preferably a fiberglass/resin system 14, can then be wound over top of it. The fiberglass 14 can be redirected around and side ports 16 via a cone-shaped plug 17, and the fiberglass 14 is only wound over the outer lip of the endcap 20, leaving enough room to have ports 22 on the injection molded endcap 20 itself. The fiberglass/resin 14 may partially cover an entire length of the tube 12.

The fiberglass-resin composite 14 then goes through a curing stage, after which the assembly is capable of withstanding a very high pressure. In the case of an air tank designed for truck air braking applications, the assembly must withstand an internal hydrostatic pressure of five times maximum rated working pressure, typically defined as 750 psi for North American commercial vehicles.

Additionally, the endcap 20 can contain a “drain port” 24 located at the bottom of the endcap 20, which the resin-impregnated fiberglass 14 can be directed around during winding. This location is also similar to how drain ports are configured in steel and aluminum air tanks. All fittings can be fitted with threaded connections such as pipe connections, or fittings that utilize o-ring seals and snap-ring mechanisms for fitting retention.

Because the fiberglass-resin matrix 14 is not wound completely over the center section of the endcap 20, a series of reinforcing ribs 26 (FIG. 2) can be molded into the concave (inside) portion of the endcap 20 to strengthen it.

Because of the high strength to weight ratio of composite materials, weight savings of around 30% over an aluminum tank, and up to 70% over a steel tank are possible.

The fiberglass 14 winding process consists of two types of layers—hoop 14.1 and helical 14.2. The hoop layers 14.1 are nearly circumferential, whereas the helical 14.2 are at a much higher angle. It is the helical layers that wrap over top of the endcap 20 to hold it in place and keep it from separating from the liner 12 when pressurized.

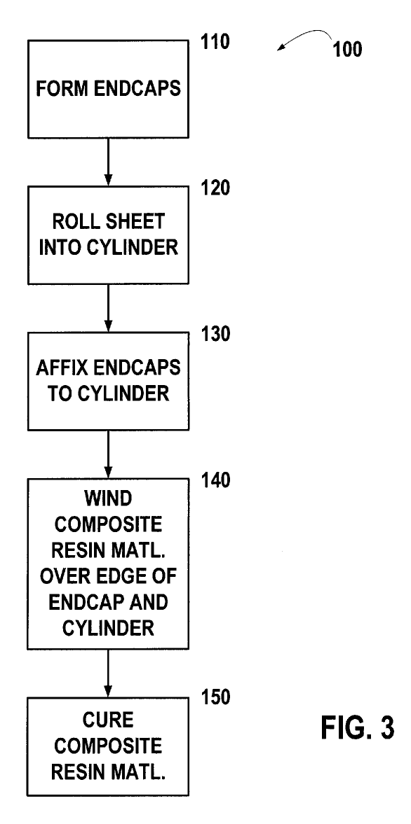

FIG. 3 illustrates a method for forming the air tank 100 described above. The end caps are initially formed 110 as injection molded parts, according to a preferred embodiment. The sheet is rolled into a cylinder 120, and the endcaps are affixed to the cylinder 130. The composite resin material is wound 140 over the edge of the endcap and the cylinder 140, and the composite resin material is subsequently cured 150.

The main advantages of this design over more conventional approaches to composite pressure vessel design are that it fits more readily into the same envelope on the truck as a metallic air tank, and that the porting is also able to duplicate the porting of a metallic air tank, from end ports, type of ports, and location of ports, including the drain port.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The particular implementations shown and described herein are illustrative examples of the invention and are not intended to otherwise limit the scope of the invention in any way. For the sake of brevity, conventional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. The word mechanism is intended to be used generally and is not limited solely to mechanical embodiments. Numerous modifications and adaptations will be readily apparent to those skilled in this art without departing from the spirit and scope of the present invention.

What is claimed is:

1. A composite air tank, comprising:
a cylindrical tube comprising two open ends;
two endcaps, at least one of which comprises one or more ports, the two endcaps being affixed to respective end portions of the cylindrical tube; and
a composite resin material that covers a portion of the endcap and a portion of the tube.

2. The tank according to claim 1, wherein the composite resin at least partially covers an entire length of the tube.

3. The tank according to claim 1, wherein the affixing is a laser weld or adhesive bonding.

4. The tank according to claim 1, wherein the tube is a rolled sheet of material.

5. The tank according to claim 1, wherein the tube is made of plastic.

6. The tank according to claim 1, further comprising a side port that is affixed to the tube.

7. The tank according to claim 6, further comprising a cone-shaped plug that affixes the side port to the tube.

8. The tank according to claim 1, wherein the composite covering is a winding that covers a portion of the tube and a portion of the endcap.

9. The tank according to claim 8, wherein the winding comprises at least one of a generally circular winding and a helical winding.

10. The tank according to claim 1, wherein the composite resin material is a fiberglass resin material.

11. The tank according to claim 1, wherein the endcap comprises reinforcing ribs.

12. The tank according to claim 1, wherein at least one port is a drainage port.

13. The tank according to claim 1 wherein the ports comprise at least one of a threading and o-ring seals with a snapping mechanism.

14. The tank according to claim 1, wherein the endcaps are injection molded endcaps.

15. A method for forming an air tank, comprising:
forming two endcaps, at least one having one or more ports;
affixing the two endcaps to respective ends of an open tube;
applying a composite resin material to cover a part of the endcaps and the tube; and
curing the composite resin material.
